(19) United States
(12) Patent Application Publication
(10) Pub. No.: US 2014/0293045 A1
(43) Pub. Date: Oct. 2, 2014

(54) SYSTEM FOR VISION RECOGNITION BASED TOYS AND GAMES OPERATED BY A MOBILE DEVICE

(71) Applicant: EYECUE VISION TECHNOLOGIES LTD., Yokneam (IL)

(72) Inventors: Ronen Horovitz, Haifa (IL); Shai Feder, Haifa (IL)

(21) Appl. No.: 14/353,509

(22) PCT Filed: Oct. 31, 2012
(86) PCT No.: PCT/IL2012/050430

§ 371 Date: Apr. 23, 2014

Related U.S. Application Data
(60) Provisional application No. 61/553,412, filed on Oct. 31, 2011.

(51) Int. Cl. A63F 13/98; G06K 9/00; H04N 7/18

(52) U.S. Cl. CPC A63F 13/02; H04N 7/183; G06K 9/00496
USPC 348/135; 382/103

(57) ABSTRACT

A system and method for capturing an image of an object with a camera of a first electronic device, identifying an object in such image with a processor of the first device by comparing the object in the image to image data stored in a memory of the first electronic device, and issuing a signal from the processor of the first electronic device to activate an output device of a second electronic device that holds the first electronic device.

### CROSS REFERENCE TO RELATED APPLICATIONS

This application is U.S. Provisional Patent Application No. 61/553,412, entitled SYSTEM FOR VISION RECOGNITION BASED TOYS AND GAMES OPERATED BY A MOBILE DEVICE filed on Oct. 31, 2011, all of which are incorporated herein by reference in their entirety.

### FIELD OF THE INVENTION

The invention pertains generally to image recognition and interactive entertainment. More specifically, this application relates to using a camera and a processor of a mobile device as an attachment to a mobile toy or game.

### BACKGROUND OF THE INVENTION

Traditional interactive toys and games use electronic components such as micro controllers, memory chips and other circuitry, and in some cases a CMOS vision or image recognition system. These components may add cost and complexity to the design and manufacturing process of the toy.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a conceptual illustration of a system in accordance with an embodiment of the invention; and

FIG. 2 is a flow diagram of a method in accordance with an embodiment of the invention.

### DETAILED DESCRIPTION OF THE PREFERRED EMBODIMENTS

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “comparing”, “combining” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution by for example one or more processors results in a method of an embodiment of the invention. In some embodiments, one or more components of a system may be associated with other components by way of a wired or wireless network. For example one or more memory units and one or more processors may be in separate locations and connected by wired or wireless communications to execute such instructions.

As used in this application, and in addition to its regular meaning, the term mobile device may refer to cell phone (cellular telephone), smart phone (smart telephone), handheld game console, tablet computer or other electronic device having a power source, processor, memory unit, image processor, input device suitable for receiving a signal or input from a user for activation of a function of the electronic device, an output unit such as a screen or loudspeaker suitable for delivering a signal, and a wireless transmitter and receiver.

As used in this application a housing may refer for example to a case, shell, or container for a cell phone, tablet, laptop or other electronic device that may include a screen such as a touch screen, other input devices such as keys, a camera or image capture device and one or more docks or ports such as a universal serial bus or other conveyors of signals from a processor or other component inside the housing of the device, to another device. In some embodiments, a housing may include for example a body of a doll, plush toy, push toy, toy car, play house, toy plane, or other toy that may include appendages such as limbs, arms, legs, wheels, treads, blinking eyes, smiling lips or other parts. Such housing may include a holder, docking-station, port or support that may hold, cradle, carry or support a cell-phone, tablet or other electronic device, and that may accept or receive signals from such device. In some embodiments a housing of a toy may also include one or more processors, memory units and activators that may move or alter a position or orientation of one or more appendages, wheels, treads or other features that are included in the housing. Some of such movements may be made in response to one or more signals from the phone or electronic device that is held by the toy or toy housing.

As used in this application and in addition to its regular meaning, the term ‘an object in an image’ may refer to captured image data of a physical object that is present in a field of view of a camera or image capture device. In some embodiments such object may be a three dimensional object such as a person, face, furniture, wall or other physical object. In some embodiments such object in an image may include a picture, marking, pattern or other printed or drawn matter on a card, sticker, paper or other mostly two-dimensional medium. In some embodiments, an object in an image may include a sticker or marking having particular colors, patterns or characteristics that are pre-defined, stored in a memory and associated with one or more instructions or objects. For example an object in an image may refer to a sticker having one or more colors or markings in a known format or pattern. Such sticker may be adhered to an object such as a wall, so that when the wall with the sticker is captured in an image, a processor may associate the pattern on the sticker with a particular instruction that is stored in a memory and associated with such pattern.

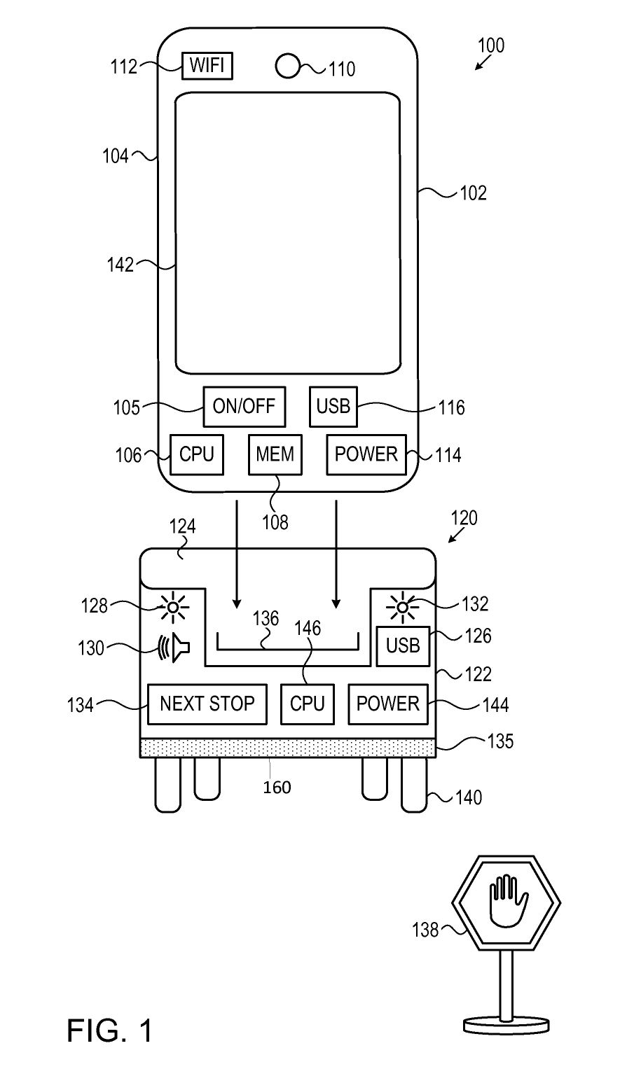

Reference is made to FIG. 1, a conceptual illustration of a system in accordance with an embodiment of the invention. A system 100 may include an electronic device 102 such as a cellular telephone, smart phone, tablet computer, or other electronic device generally including a housing 104 where the housing holds, encases or includes one or more processors 106, memory 108 units, image capture devices such as cameras 110, transmitters and receivers of wireless communication signals 112 such as for example cellular telephone signals, Bluetooth signals, Infrared signals or other wireless communication signals, power sources such as a battery 114, and one or more connectors 116 such as a universal serial bus (USB), an audio jack or other conveyor of electronic signals from for example processor 106 to connections outside of device 102. In some embodiments, such connector 116 may be for example a female segment of a USB or other port that may detachably connect to a male port or connector, to exchange for example signals or convey power or control commands. Device 102 may also include one or more input devices such as one or more keys 105, a touch display 142, a microphone or other buttons.

A second device 120 may include a housing 122 that may encase or include a holder 124 to releasably hold some or all of housing 104 of electronic device 102, as well as a signal receiver 126 to receive signals such as command signals from electronic device 102 as may be conveyed through for example connector 116 or wirelessly (such as by Bluetooth) or by some other means, from electronic device 102. In some embodiments, signal receiver 126 may be or include a port or other connection that may link with a port or connection of device 102 to receive electronic output signals from device 102. In some embodiments, signal receiver 126 may be or include a wireless antenna or receiver of wireless signals such as IR, WiFi, Bluetooth, cellular or other wireless signals.

Device 120 and housing 122 may also include a processor 146 and one or more output devices 128 that may be configured to be activated upon receipt of a signal by device 120 conveyed from device 102. Output device 128 may include one or more of for example a loudspeaker 130 that may be included in housing 122 that may issue audio or voice data, one or more lights 132, one or more screens or digital displays 134 or one or more activators 135 such as an activator to move one or more appendages, segments or part of device 120 in housing 122. In some embodiments, housing 122 may be in the form of a wagon, carriage, car, doll shape, toy shape or other shape that may encase some or all of housing 104. For example, housing 122 may be or include a fabric, plastic or other material into which some or all of housing 104 may be inserted, help or contained. In some embodiments, housing 122 may hold housing 104 at a know angle and position relative to housing 122, so that an angle of view of camera 110 is known relative to a position of housing 122.

In operation, device 102 may be detachably placed into a holder or cradle of device 120, where device 102 may be or include a smartphone and device 120 may be or include a housing in the shape of for example a doll, toy car or other toy. A positioning and orientation of device 102 relative to device 120 when it is held in device 120 may be known in advance so that for example a cradle 136 or holder of device 120 may hold device 102 in a known position, such as with camera 110 facing forward at a known angle. When device 102 is held or supported by cradle 136, camera 110 may capture images of objects in front or at a known orientation to device 120.

Processor 106 may evaluate objects 138 in the captured image, and may compare one or more of such objects 138 to data stored in memory 108 to detect that the object 138 in the captured image matches image data stored in memory 108. Objects 138 such as faces, may be identified using one or more of available face recognition functions. Objects 138 such as printed matter may be identified by one or more of color, pattern, size, text recognition or other image processing functions for object recognition. In response to an identification of object 138 by for example a successful comparison of object 138 with data stored in memory 108, processor 106 may issue a signal that may be transmitted wirelessly or through for example connector 116 to device 120. Such signal may instruct device 120 to activate output device 128 to take a certain action. For example, when a card or picture with a pre-defined pattern is identified as an object 138 in an image captured by camera 110, processor 106 may signal loudspeaker 130 in doll device 120 to output voice data to say “That's an A”. In another example, when a face is a recognized object 138, processor 106 may signal an activator 135 to move or alter a position of one or more appendages or other parts of device 120 such as to move a face of doll example of device 120 into a smile configuration, or to activate lights 132 to brighten eyes of device 120, such as a doll, or to move a hand, arm foot or other appendage of device 120, such as a doll, to waive, walk or take some other action or movement. In some embodiments, processor 106 may recognize a series of objects 138 in a series of images captured by camera 110, and may signal treads, wheels 140 or other locomotive devices on device 120 that may alter a location of device 120 holding device 102, such as a toy car, to move in a direction of object 138 so as for example to keep object 138 in a center or other designated area of a captured image or to another position or location relative to device 102 and camera 110.

When device 120 moves, it may carry device 102 with it in for example cradle 136.

In some embodiments, a user may select a person or other object 138 in an image captured by camera 110, and store image data of such object in memory 108. A user may browse memory 108 to find and select the stored image, and issue a signal by way of for example touch display 142, for processor 106 and camera 110 to capture further images and find and identify object 138 in such captured images. Upon such identification, processor 106 may signal device 120 carrying device 102 to move in a direction of such object in the further captured images.

In some embodiments, device 120 may be or include a self propelled carriage 160 for releasably holding device 102, and a signal from device 102 may command the carriage holding device 102 to move the carriage and device 102 in compliance with an instruction. For example, a command may instruct the carriage to move towards the identified object 138 in the image. A command may instruct the carriage to move towards object 138 so that the object in the image remains in for example a center of a series of images that are captured by camera 110 while device 120 is moving. In such case, feedback from processor 106 as to a drift of object 138 away from a center, predefined area or other coordinate of an image, may be translated into instructions to change or alter a direction of the movement of device 120.

In some embodiments, a toy car or other vehicle may be radio controlled or controlled by some other wireless format that may be received by device 102.

In some embodiments, images may be captured of plastic or other material objects which symbolize traffic signs—stop sign, different speed signs, turn left/right or other signs, and processor 106 may associate captured images with one or more instructions. A player can put these in free space and let the toy car drive and behave according to those signs it sees on its way. A method and system of such object recognition based on visible characteristics is set out in US Application 20100099493 filed on Apr. 22, 2010 and entitled System and Method for interactive toys based on recognition and tracking of pre-programmed accessories, incorporated herein by reference.

In some embodiments, cradle 136 may include a holder with a docking station to hold device 102 at a known orientation to such docking station, such as a male USB port or receiver 126, so that when device 102 is held in holder 124 and rests in cradle 136, connector 116 is aligned with and detachably engaged with receiver 126, and so that signals and/or power can be conveyed from device 102 to device 120. Device 120 may also include its own power source 144.

In some embodiments cradles 136 of various sizes and configurations may be inserted and removed from holder 124 to accommodate various sizes and configurations of devices 102.

In some embodiments, holder 124 may be positioned for example in a head of a doll as device 120 so that camera 110 looks through for example a transparent eye or other orifice of the dolls head, and so that images captured by camera 110 obtain a perspective similar to what would be viewed by an eye of such doll.

Objects 138 may include particular objects such as cards, pictures, toy accessories that may have particular colors, shapes or patterns that may be printed or otherwise appear on such objects, or may include generic objects such as faces, walls, furniture or barriers that may impede a movement of device 120. In some embodiments, a pattern, color or shape on object 138 may be associated in memory 108 with a cue or instruction, and processor 106 may issue a signal to for example activator 135 to take an action associated with such cue or instruction.

In some embodiments, processor 106 may recognize objects 138 such as cards by the images printed on the cards or on recognition of visual cues such as codes that are associated with the images on the cards. The recognition of a specific card or set of cards might trigger audio feedback such as voice or other sounds or visual feedback from the mobile device such as may appear on an electronic display 142 of device 102. Such card objects 138 may be cards with educational content printed on them such as letters, numbers, colors and shapes or they can be trading cards such as baseball players, basketball players. Objects may include graphical content printed inside and the content may be framed in a boundary of codes or frames.

Objects 138 may be designed or customized by a user using dedicated software or on an internet website, so that an image of an object 138 may be inputted by a user into for example memory 108, and a designated action may be taken by output device 128. or example, a user may design and store in memory 108 an image of an object or character or other figure and associate a code, a tag or label with such image. When printed, an object with the image affixed thereon may be recognized as the tag or label the user selected when designing it. A method and system of such card recognition may be as described in U.S. Pat. No 8,126,264 issued on Feb. 28, 2012 and entitled “Device and Method for Identification of Objects using Color Coding”, incorporated herein by reference. A method and system of such card recognition based on monochromatic codes is set out in US Pat. Application 20100310161, filed on Dec. 9, 2010 and entitled “System and Method for Identification of Objects Using Morphological Coding”, incorporated herein by reference. A method and system of such card recognition based on framed content is set out in PCT Application /IL2012/000023 filed on Jan. 16, 2012 and entitled “System and Method of Identification of Printed Matter in an Image Processor”, published as WO 2012/095846, incorporated herein by reference.

In some embodiments, device 102 may be mounted or placed into for example a play set such as a doll house. Recognition of an object 138 may be based on visual cues recognized by processor 106 from an image captured by camera 110. For example an image may be captured that includes a color of a doll or a doll accessory, a texture of the doll's outfit or even features of the doll's face. A method and system of such object recognition based on visible characteristics is set out in US Application 20100099493 filed on Apr. 22, 2010 and entitled “System and Method for Interactive Toys Based on Recognition and Tracking of Pre-Programmed Accessories”, incorporated herein by reference.

In some embodiments, device 102 may be attached to or mounted on a housing of a toy that may be for example designed as a fashion themed playset such as a mirror playset. An accessory to be recognized may be for example a face such as a doll or a player's face. Device 102 may recognize the outfit of the doll or the player based on face detection and localization of the outfit in relation to the position of the face. Device 102 may be incorporated into a mirror-like housing such as toy furniture inside a doll house, and a user may place a doll in front of camera 110 that is hidden behind such mirror or display 142 of device 102 may serve as a mirror by displaying a preview of image captured by camera 110. Recognition may be based on locating a face of the doll, by using a face detection algorithm or by creating a more specific doll face detection algorithm. Recognition may be based on locating a face of a player by using face detection methods or locating a face of a player which has his face painted with face painting.

Once a face is detected, an area which is located under the face in the image captured by camera 110 in a relative distance to the found face size may be used to characterize the outfit of the doll in terms of its colors, shape, texture, etc.

An example of a specific face detection algorithm may be as follows: If the doll has make up on its face, making her eyes look blue and her lips look purple, then looking at the captured image in a different color space, such as (Hue Saturation Value) HSV for example, may allow extraction of a template of that face configuration in the Hue space, as the eyes will have a mean value of blue, for example—0.67, the lips will have a mean value of purple, for example—0.85, and the face itself may have a mean value of skin color, for example—0.07. Such a template may be found in the Hue image by for example using two-dimensional cross correlation or by other known methods. Such algorithm may incorporate morphological constraints such as a grayscale hit-or-miss transform to include spatial relations between face colored segments in the detection process.

When a face is detected, an area in the image, located for example under the face, may be further analyzed for recognition of the outfit. The recognition may be based on color, texture and other patterns. Recognition may be based on color as the mean Hue value of the area representing the outfit, and may be classified from a pre-defined database of outfits. The recognition of the doll's outfit may trigger an audio response from output device 128 or an image or video or other response showing that doll with that specific outfit in a new scene. In a fashion game, for example, an audio response may give feedback about fashion constrains that are noticeable in the recognized outfit.

In some embodiments such recognition may allow distinguishing or finding a class of objects from among other classes of objects, such as for example, a ball among several bats. In some embodiments, such recognition may allow finding or distinguishing a face of a particular person from among several faces of other people. In some embodiments, detection of an object may include detection of a barrier or impediment that may block a path or direction of progress of device 120. For example, a cell phone or other portable electronic device 102 may be inserted into for example an automated vacuum cleaner as an example of a device 120. Camera 110 of device 102 may detect and/or identify walls, furniture, carpet edges, or other objects that may impeded a path or define a recognized area of function of the vacuum cleaner, such as a particular carpet of which an image may have been stored in memory 108, that the user desires the cleaner to vacuum.

A doll outfit may include several parts such as shirt and pants, or from one part such as a dress. Further analysis may distinguish different parts from each other by using clustering or other segmentation methods based on color and texture. A specific doll or action figure may be recognized from a set of known dolls by face recognition algorithms for example based on 2D correlation with the database of a known set of dolls.

In some embodiments, device 102 may be mounted inside a doll form or housing such as a fashion doll or baby doll. A toy with camera 110 embedded in the device 102 that is held inside or on the toy housing may provide feedback based on face recognition of the player or facial expressions of one or more players.

In some embodiments, device 102 may be used instead of or in addition to playing pieces on a board game. For example in a game of chess, device 102 may take a place of a pawn or other piece. In Monopoly™, device 102 may take the place of a player's game piece, so that instead of using a traditional plastic piece, device 102 may be used. In such an embodiment, device 102 may be placed on a game board or mat, and may automatically detect its location, orientation and overall position on the board by capturing images from camera 110 and comparing features of the board extracted from images of the board, to a database of known features of the board. Board features may include a grid which is printed along with the content on the printed board game, or specific game contents such as a forest or river or other printed items with a special pattern which is printed on the board. The board may include heightened physical or transparent plastic or other material attached to the board, thereby adding height above the board to allow the camera additional height to focus on the printed board.

Device 102 may rest in a wagon, carriage or other holder that may serve as device 120, and a detection and recognition of a location of device 120 on the board, or an action of the game may trigger audio or visual output from device 120. Device 120 may be or include a transparent carrier, with for example with a wide angled lens, to help add height and enlarge the field of view of camera 110.

Detecting a position of the device 102 as it rests in device 120 may also be achieved without physical support that raises the device. When a player starts lifting the device 102 over the board, processor 106 may estimate a height of the device 102 position until the player stops moving the device 102, and then the user may receive a signal from the device 120 that the position is known and the device 102 may be put back on the board.

Such content may be related to the location or state of the player represented by device 102. For example, in a Monopoly™ game, content such as audio or image feedback may be output announcing that a player landed in jail, and showing a jail graphic representation.

Detection of position and orientation of device 102 may be continuous, to allow a player to move his device 102 and see a graphical representation of a character moving, rotating and standing on display 142 in accordance with the device 102.

By adding wireless communication between several mobile devices used as game pieces that know their locations on a game board, two or more players may interact by having a play event take place on more then one device at a time. For example, a player may swipe his finger on a touch screen of a mobile device to stretch a graphical bow or sling shot on the screen, while physically moving his mobile device to aim it toward another mobile device, and releasing his finger to take a shot. The mobile device which was the target of such an arrow shot may show graphical representation of a hit or miss. Use of devices 102 in a game context may allow a combining of automatic location detection on a game board, and the production of output such as sound effects and graphical effects in response to actions of the game.

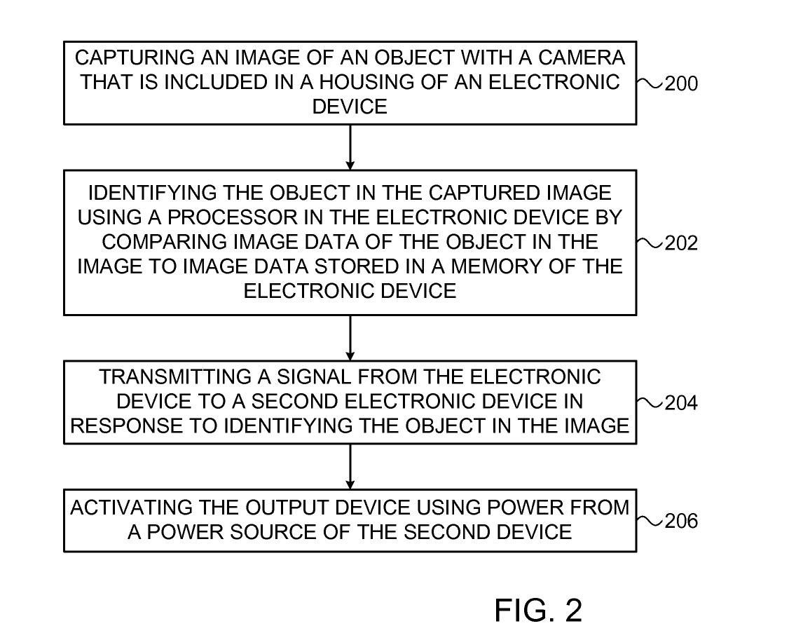

Reference is made to FIG. 2, a flow diagram of a method in accordance with an embodiment of the invention. The operation of FIG. 2 may be performed using the system of FIG. 1 or using another system. Embodiments may include a method for triggering an activation of an output device or activator in response to detecting of an object in an image. In block 200, an embodiment of the method may include capturing an image of an object with a camera that is included in a housing of an electronic device. In block 202, embodiments of the method may identify the object in the captured image using a processor in the electronic device to compare image data of the object in the image to image data stored in a memory of the electronic device. In block 204, a method may include transmitting a signal from the electronic device to a second electronic device in response to the identifying of the object in the image. The second electronic device may be releasably holding, supporting or carrying the first electronic device. The transmitted or conveyed signal may activate an activator or output device that is included in or connected to the second electronic device. In block 206, the method may include activating the output device using power from a power source of the second device. In some embodiments, a processor in a second electronic device may receive for example a signal to activate an output device that may be housed or included in such second electronic device, and may receive certain command instructions relating to such activation. In some embodiments, a processor in the first device may transmit signal such as activation and/or control signals that may be transmitted to the second electronic device or to a particular activator or output device of the second electronic device, such that the processor in the first device may control all or certain functions of the output device in the second electronic device.

In some embodiments, transmitting a signal from the first device to the second device may include transmitting from a female port such a USB on the first electronic device through a male port on the second electronic device. In some embodiments, activating the output device may include activating a loudspeaker of the second electronic device to speak or produce words. In some embodiments, activating the output device may include activating a locomotion device attached to the second electronic device to move the second electronic device as it carries the first electronic device. In some embodiments, transmitting a signal may include transmitting a signal that includes an instruction that is associated in a memory with the object that is identified in the image. In some embodiments, the first device and its camera may be held in the second device at a known orientation relative to the surface upon which the second device rests, and the locomotion device may alter the location of the second device relative to a position of the object in the image.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

It will be appreciated by persons skilled in the art that embodiments of the invention are not limited by what has been particularly shown and described hereinabove. Rather the scope of at least one embodiment of the invention is defined by the claims below.

I claim:

1. A system comprising:
a first electronic device, said first electronic in a housing, said housing including
a processor,
a memory,
a battery,
an image capture device,
a display screen,
a transmitter and receiver configured for wireless communication, and
a signal conveyor suitable for conveying electronic signals from said first electronic device to a second device;
said second device comprising a housing of said second device, said housing of said second device comprising:
a holder to releasably hold said housing of said first electronic device,
a signal receiver to receive said signals from said first electronic device and
an output device, configured to be activated upon receipt of a signal of said conveyed electronic signals
wherein upon detection by said processor of an object in an image captured by said image capture device, said first electronic device transmits a signal to said second electronic device, said signal to activate said output device; and
wherein said output device is activated by said signal.

2. The system as in claim 1, wherein said output device comprises an activator to alter a position of at least a part of said second device in response to said signal of said conveyed electronic signal.

3. The system as in clam 1, wherein said second output device comprises a locomotion device to alter a location of said second device including said first electronic device in response to said signal of said conveyed electronic signal.

4. The system as in claim 3, wherein said image capture device is in a known orientation relative to said second device, and wherein said locomotion device is to alter said location of said second device relative to a position of said object in said image.

5. The system as in claim 1, wherein said memory is to store image data of said object in said captured image and an association of said image data with an instruction for said output device, and wherein upon said detection, said signal comprises a signal to activate said output device using said instruction.

6. The system as in claim 5, wherein said output device comprises a speaker, said speaker to output voice data associated with said object.

7. The system as in claim 1, wherein said output device comprises a speaker and an activator.

8. The system as in claim 1, wherein said second device includes a battery and a processor.

9. The system as in claim 1, wherein said signal conveyor comprises a female universal system bus port, and wherein said signal receiver comprises a male universal system bus port, and said signal conveyor is aligned with and detachably connected to said signal receiver when said first electronic device is held in a cradle of said second electronic device.

10. A method for triggering activation of an output device in response to detecting an object in an image, the method comprising:
capturing an image of said object with a camera of a first electronic device; and
identifying said object in said image by comparing with a processor of said first electronic device, image data of said object in said image, to image data stored in a memory of said first electronic device;
transmitting from said first electronic device to a second electronic device, a signal in response to said identifying, said second electronic device releasably holding said first electronic device, said signal to activate an output device of said second electronic device; and
activating said output device of said second electronic device with power from a power source of said second electronic device.

11. The method as in claim 10, wherein said transmitting comprises transmitting said signal from a female port on said first electronic device through a male port on said second electronic device.

12. The method as in claim 10, wherein said object comprises an object having printed matter thereon, and said identifying comprises identifying said object with said printer matter.

13. The method as in claim 10, wherein said activating said output device comprises activating a locomotion device attached to said second electronic device to move said second electronic device, said second electronic device holding said first electronic device.

14. The method as in claim 13, wherein said signal includes a signal to move said second electronic device in response to an instruction associated with said object.

15. The method as in claim 13, wherein said camera is in a known orientation relative to said second electronic device, and wherein said locomotion device is to alter said location of said second device relative to a position of said object in said image.

16. The method as in claim 10, wherein said activating said output device comprises activating said output device to alter a position of an appendage of said second electronic device.

17. A system comprising:
a wireless communication device, said wireless communication device including a
housing, said housing containing
a processor;
a memory;
a display;
a wireless signal receiver and signal transmitter;
a camera; and
a power source;
a self propelled carriage for said wireless communication device, said carriage including
a holder to releasably hold said wireless communication device;
a signal receiver to receive command signals from said wireless communication device
a locomotion means to alter a position of said carriage
a power source
wherein
said camera is to capture an image, said image including an object,
said processor is to:
compare image data of said object in said image to image data stored in said memory;
associate said object with an instruction stored in said memory; and
issue a signal to said signal receiver to move said carriage holding said device, using said locomotion means in compliance with said instruction.

18. The system as in claim 17, wherein said signal is transmitted from said device to said carriage using said wireless transmitter.

19. The system as in claim 17, wherein said signal directs said locomotion device to move said carriage holding said device towards said object in said image.

20. The system as in claim 19, wherein said signal directs said locomotion means to move said carriage holding said means in a direction to keep said object in a predefined area of said image.
